(19) United States
(12) Patent Application Publication
(10) Pub. No.: US 2013/0275914 A1
(43) Pub. Date: Oct. 17, 2013

(54) ELECTRONIC DEVICE AND METHOD FOR CONTROLLING TOUCH PANEL

(71) Applicant: Xiao-Yi ZHUO, Shanghai (CN)

(72) Inventor: Xiao-Yi ZHUO, Shanghai (CN)

(21) Appl. No.: 13/605,584

(22) Filed: Sep. 6, 2012

(30) Foreign Application Priority Data
Apr. 12, 2012 (CN) 201210106907.7

(51) Int. Cl. G06F 3/041; G06F 3/048

(52) U.S. Cl. 715/810

(57) ABSTRACT

An electronic device and its method for controlling touch panel are disclosed. The electronic device includes a touch panel and a processing module. The touch panel displays a functional menu. The processing module analyzes a movement trajectory formed by the plurality of input signals to obtain each input area passed by the movement trajectory and a receiving sequence. The processing module controls a display location of the functional menu to be displayed in the touch panel based upon the input area and the receiving sequence. The processing module determines whether or not the first block is greater than the second block in the plurality of input areas corresponding to the input signal. When the first block is greater than the second block, the touch panel starts the first mode. When the first block is smaller than the second block, the touch panel starts the second mode.

### CROSS-REFERENCE TO RELATED APPLICATION

This application claims the benefit of China Patent Application No. 201210106907.7, filed on Apr. 12, 2012, in the State Intellectual Property Office of the People's Republic of China, the disclosure of which is incorporated herein in its entirety by reference.

### BACKGROUND OF THE INVENTION

1. Field of the Invention

The present invention relates to an electronic device and its method for controlling touch panel, and more particularly to an electronic device which is larger than four inches in size that can be operated by a single hand and a method for easily controlling and operating its touch panel.

2. Description of the Related Art

Since a consumer electronic device having a touch panel has a user friendly interface, it is so popular that it has become a main technology field. Currently, the application of the touch panel is widely applied to various electronic products, such as ATMs, hand-held game consoles or smart phones. The size of the touch panels may be diverse to meet different demands. Taking a cell phone as an example, an earlier non-smart phone is equipped with a screen having one inch to three inch. Afterward the size of an earlier smart phone has been increased to above 2.8 inches. The touch panel of an iPhone and an Android cell phone is further increased to 3.5 inches. Moreover, a cell phone screen having five inches is presented to the public. Taking a tablet computer for example, some companies also design panels with size ranging from four inches to ten inches so as to meet different habits and demands of users.

The touch panel having larger size can be clearly seen by the user. However, the touch panel may be difficult to be held and instantly operated by a single hand if the size of the touch panel is larger than four inches. When the user would like to operate the touch panel through a left hand or the single hand, the electronic device having the touch panel must be placed at a stable location. For the user, a portable electronic device, such as the tablet computer or the smart phone, must have advantages of convenience and portability. If the electronic device must be placed at a stable position to achieve single-hand-operation, it is not convenient.

Therefore, designing an electronic device, in which the size is larger than four inches, and a method for controlling the touch panel capable of being easily operated by a single hand becomes an important issue that needs to be overcome.

### SUMMARY OF THE INVENTION

In view of the shortcomings of the prior art, the inventor(s) of the present invention based on years of experience in the related industry to conduct extensive researches and experiments, and finally developed an electronic device and its method for controlling touch panel as a principle objective so that a user can conveniently operate a touch apparatus having a large screen (more than four inches) through a single hand.

To achieve the foregoing objective of the invention, an electronic device is provided and comprises a touch panel and a processing module. The touch panel displays a functional menu and comprises a plurality of input areas to receive a plurality of input signals. The plurality of input areas comprises a center line location. Two sides of the center line location are respectively a first block and a second block. The processing module is electrically connected to the touch panel and analyzes a movement trajectory formed by the plurality of input signals to obtain each input area passed by the movement trajectory and the receiving sequence and controls a display location of the functional menu to be displayed on the touch panel based upon each input area and the receiving sequence. The processing module determines whether or not the first block is greater than the second block in the plurality of input areas corresponding to each input signal. When the first block is greater than the second block, the touch panel starts a first mode. When the first block is smaller than the second block, the touch panel starts a second mode.

If the movement trajectory is a trajectory that is from a left side to the right side back and forth or a trajectory that is from the right side to the left side back and forth, the touch panel starts a two-hand mode.

The two-hand mode is to display the functional menu at the plurality of input areas of the touch panel.

The first mode is a left hand mode, and when the touch panel starts the first mode, the functional menu is displayed at a left area of the touch panel.

If the touch panel receives the plurality of input signals from the left side to the right side, the touch panel starts the left hand mode.

The second mode is a right hand mode, and when the touch panel starts the second mode, the functional menu is displayed at a right side area of the touch panel.

If the touch panel receives the plurality of input signals from the right side to the left side, the touch panel starts the right hand mode.

The processing module is to dispose the first block at the left side of the center line location and dispose the second block at the right side of the center line location.

The processing module determines that the first block equals the second block in the plurality of input areas corresponding to each input signal, and when the input area corresponding to a last input signal in the plurality of input signals locates at the first block, the touch panel starts the second mode.

The processing module determines that the first block equals the second block in the plurality of input areas corresponding to the input signal, and when the input area corresponding to a last input signal in the plurality of input signals locates at the second block, the touch panel starts the first mode.

The electronic device further includes a storage module. The storage module is used for storing the input area corresponding to the input signal and the receiving sequence of the input signal received by the touch panel.

The processing module divides the touch panel into the plurality of input areas, and the plurality of input areas is further separated into the first block and the second block.

According to the objective of the invention, a method for controlling touch panel is provided and applied in an electronic device. The electronic device includes a touch panel and a processing module. The touch panel comprises a plurality of input areas. The plurality of input areas comprises a center line location. Two sides of the center line location are respectively a first block and a second block. The method for controlling the touch panel comprise the following steps of providing the touch panel to display a functional menu; receiving a plurality of input signals through the touch panel; analyzing a movement trajectory formed by the plurality of input signals through the processing module to obtain the input areas passed by the movement trajectory and a receiving sequence; utilizing the processing module to control a display location of the functional menu to be displayed on the touch panel based upon the input areas and the receiving sequence; and determining whether or not the first block is greater than the second block in the plurality of input areas corresponding to the input signal, wherein when the first block is greater than the second block, the touch panel starts the first mode, and when the first block is smaller than the second block, the touch panel starts the second mode.

The electronic device and its method for controlling touch panel according to the invention have one or more advantages as the following:

A conventional touch panel larger than four inches is difficult to be held and immediately operated by a single hand. The electronic device of the invention can overcome the foregoing problem so that a user can operate its touch panel through the single hand.

The electronic device and its method for controlling touch panel according to the invention can obtain the input area and the receiving sequence based upon the movement trajectory inputted by the user to control a display location of the function menu having functional icons, buttons or a scroll on the touch panel.

### BRIEF DESCRIPTION OF THE DRAWINGS

FIG. 1 a block diagram of an electronic device according to the invention;

FIG. 2 is a first schematic diagram of an electronic device according to a first embodiment of the invention;

FIG. 3 a second schematic diagram of an electronic device according to a first embodiment of the invention;

FIG. 4 is a third schematic diagram of an electronic device according to a first embodiment of the invention;

FIG. 5 is a first schematic diagram of an electronic device according to a second embodiment of the invention;

FIG. 6 is a second schematic diagram of an electronic device according to a second embodiment of the invention;

FIG. 7 is a third schematic diagram of an electronic device according to a second embodiment of the invention;

FIG. 8 is a flowchart of a method for controlling touch panel according to a first embodiment of the invention;

FIG. 9 is a schematic diagram of an electronic device according to a third embodiment of the invention;

FIG. 10A is a first flowchart of a method for controlling touch panel according to a second embodiment of the invention; and

FIG. 10B is a second flowchart of a method for controlling touch panel according to a second embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

The electronic device of the invention can be portable electronic devices having touch panels such as a tablet PC, a smart phone, a personal digital assistant (PDA), an ultra-mobile PC (UMPC), a navigation device, an e-book, a portable game console or an electronic dictionary. To further understand the technical feature of the invention, the following example takes, but not limited to, the tablet computer as the embodiment. Meanwhile, the preferred embodiment of the invention can, but not limited to, be applied to a touch panel larger than four inches.

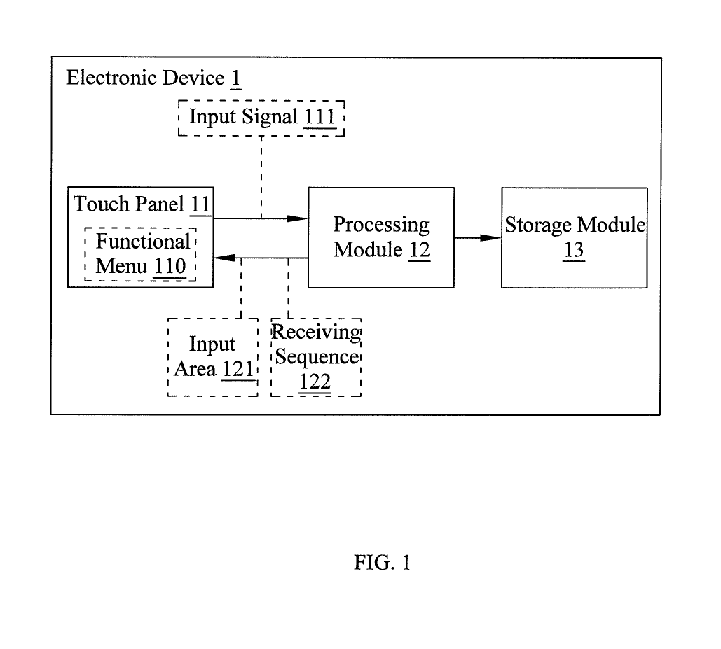

With reference to FIG. 1 for a block diagram of an electronic device of the invention is depicted. As shown in FIG. 1, the electronic device 1 includes a touch panel 11, a processing module 12 and a storage module 13. The touch panel 11 can display a functional menu 110 and includes a plurality of input areas 121 for receiving a plurality of input signals 111, and the plurality of input areas 121 includes a center line location. Two sides of the center line location are respectively a first block and a second block. The processing module 12 can be a central processing unit (CPU) or a micro processing unit and can be electrically connected to the touch panel. Simultaneously, the touch panel 11 is divided by the processing module 12 into a plurality of input areas 121. The plurality of input areas 121 is divided by the processing module 12 into the first block and the second block. Next, the processing module 12 can analyze motion trajectories formed by the plurality of input signals 111 to obtain each input area 121 passed by the motion trajectories and receiving sequences 122. The display location of the functional menu 110 displayed in the touch panel 11 is controlled according to the input area 121 and the receiving sequence 122. In another word, the processing module 12 can control each menu, icons, buttons or scrolls, which are displayed at the corresponding locations of a left side, a right side, an upper side or a lower side of the touch panel 11 based upon the area and sequence on the touch panel 11 inputted by the user. For example, if the touch panel 11 receives the plurality of input signals 111 from the left to the right, the processing module 12 can control the touch panel 11 to start a left hand mode. If the touch panel 11 receives the plurality of input signals 111 from the right to the left, the processing module 12 can control the touch panel 11 to start a right hand mode.

Further, in the plurality of input areas 121 corresponding to each input signal 111, the processing module 12 can determine whether or not the first block is larger than the second block. When the first block is larger than the second block, the touch panel 11 starts a first mode. When the first block is smaller than the second block, the touch panel 11 starts a second mode. In other words, the first mode can be the left hand mode. When the touch panel 11 starts the left hand mode, the functional menu 110 can be displayed at the left hand side area of the touch panel 11. The second mode can be the right hand mode. When the touch panel 11 starts the right hand mode, the functional menu 110 can be displayed at the right hand side area of the touch panel 11.

In addition, if a user would like to release the first mode or the second mode of the touch panel 11, a two-hand mode of the touch panel 11 can be started by a trajectory of left to right back and forth or a trajectory of right to left back and forth such that the functional menu 110 can be displayed on the plurality of areas 121 of the touch panel 11 capable of being operated by two hands.

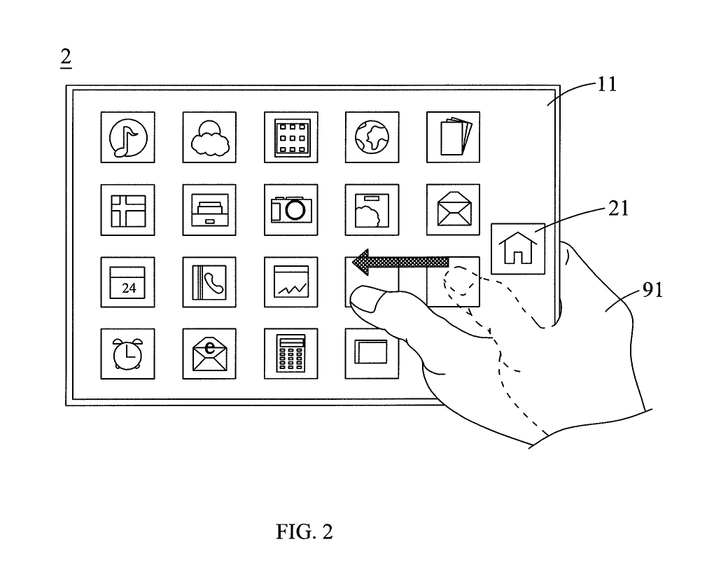

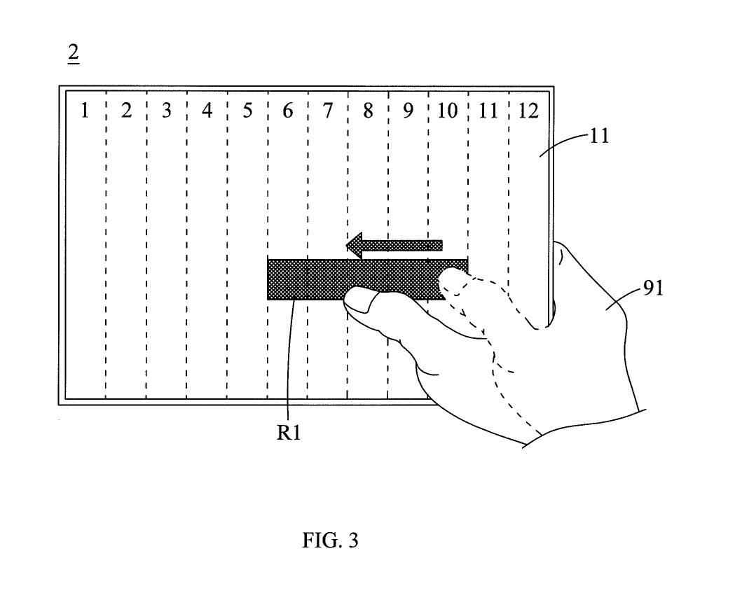

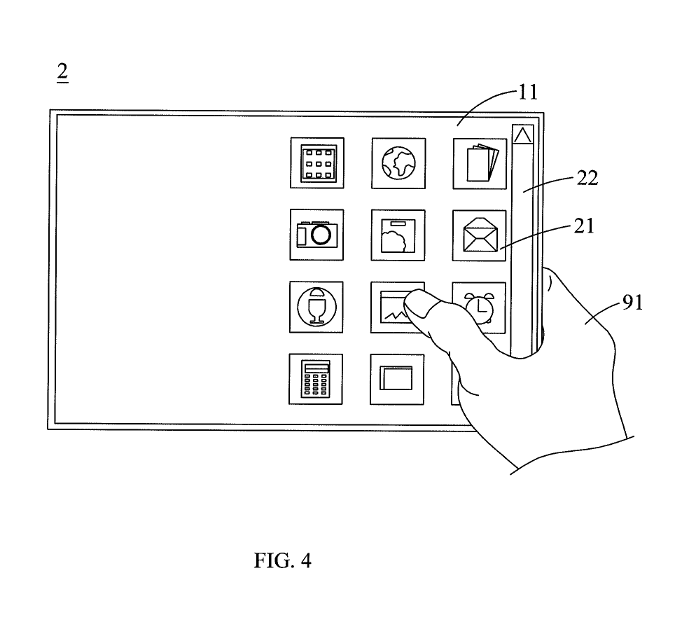

With reference to FIG. 2, FIG. 3 and FIG. 4 for a first schematic diagram, a second schematic diagram, and a third schematic diagram of an electronic device according to a first embodiment of the invention are depicted. Generally, the touch panel 11 larger than four inches is difficult to be simultaneously held and operated by a single hand. The electronic device 2 of the invention can resolve the foregoing problems. The user can use the right hand 91 to operate the touch panel 11. The electronic device 2 of the invention includes the touch panel 11, and preferably, the touch panel 11 larger than four inches can be applied. As shown in FIG. 2, many icons 21 are displayed in the touch panel 11 and are functional menus. The user can select these icons 21 to start their functions. When a quantity of the icons 21 fully occupies the touch panel 11, it is difficult for a user to operate all of these icons 21 by the single hand. Therefore, the touch panel 11 can be electrically connected by the processing module of the invention. When the user touches the touch panel to input many input signals through a single finger at a direction of right to left, the processing module analyzes a movement trajectory formed by many input signals from the user to obtain the input area passed by the movement trajectory and receiving sequence.

As shown in FIG. 3, the touch panel 11 includes a center line location that is between number six and number seven. In the embodiment, the left side of the center line location is the first block while the right side of the center line location is the second block. An input area R1 is crossed and touched by the thumb of the right hand 91 of the user is number six to number ten. The serial number of the receiving sequence of the input signals received by the processing module in the input area R1 is number ten, number nine, number eight, number seven, and number six. Accordingly, the processing module can control the location of these icons displayed therein based upon the input area R1 and the receiving sequence and determines that the first block covering the two sides of the center line location in the input area R1 corresponding to the input signal is smaller than the second block so that the touch panel 11 can start the second mode as the right hand mode.

Therefore, as shown in FIG. 4, the user can use his/her right hand 91 to individually control the touch panel 11. Not only is the display location of the functional menu at the second block of the touch panel 11, but also displays the scroll 22 displayed by the touch panel 11 at the second block. It should be noted that those skill in the art can randomly define locations of the first block, the second block and the center line or divide these blocks into smaller units having many functions and depends upon the design.

Next, according to the first embodiment, the invention further provides a second embodiment for detail depiction.

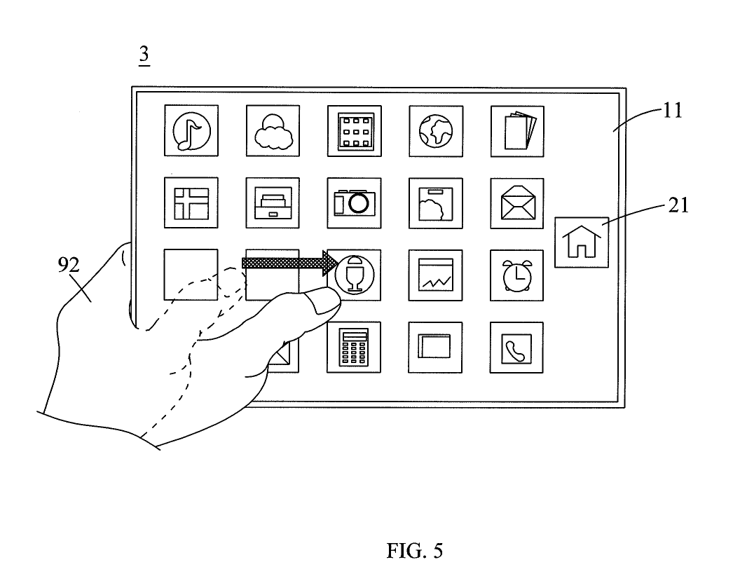

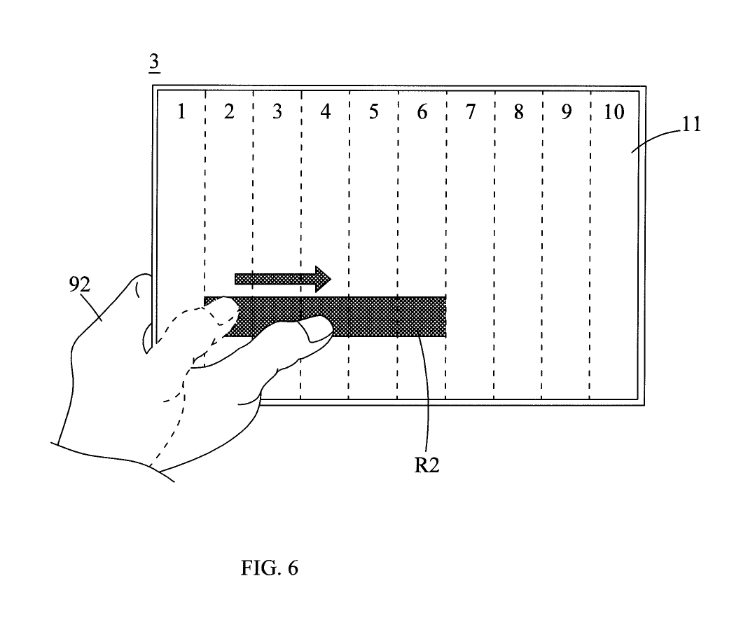

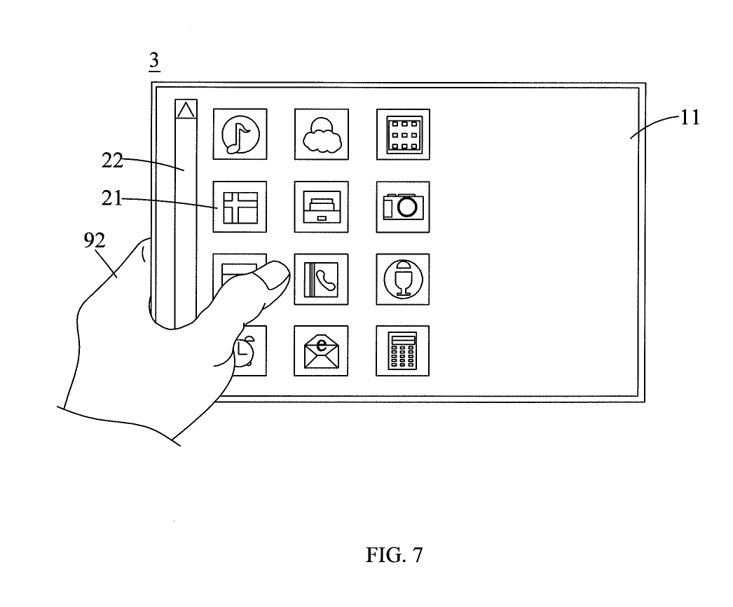

With reference to FIG. 5, FIG. 6 and FIG. 7 for a first schematic diagram, a second schematic diagram and a third schematic diagram of an electronic device according to a second embodiment of the invention are depicted. Generally, a left-handed person or a user who habitually practices his/her left hand is good at daily activities such as writing or article operation. Therefore, times of using the left hand are greater than the right hand. As shown in FIG. 5, when the user utilizes the left hand 92 to operate the touch panel 11 of the electronic device 3, many input signals can be inputted by sliding on the touch panel 11 from the left side to the right side through fingers of the single hand. The processing module analyzes the input area passed by the movement trajectory and the receiving sequence of the input signal based upon the movement trajectory generated by many input signals.

The processing module can analyze the input area passed by the movement trajectory and the receiving sequence of the input signal based upon the movement trajectory generated by many input signals. As shown in FIG. 6, the touch panel 11 includes a center line location between number five and number six. In the embodiment, the left side of the center line location is the first block while the right side of the center line location is the second block. The input area R2 passed by the movement trajectory is number two to number six. The receiving sequence of the input signal corresponding to the input area R2 is number two, number three, number four, number five and number six. Accordingly, the processing module can determine that a direction inputted by the user is from the left side to the right side based upon the input area R2 passed by the movement trajectory and the receiving sequence, and the inputted area is that the first block is greater than the second block. At this time, the processing module can control the touch panel 11 to start the first mode. The user can easily operate the screen through the left hand 92.

In another words, as shown in FIG. 7, the user can independently operate the touch panel 11 through the left hand 92. Not only the location of the icon 21 is displayed at the first block of the touch panel 11, but also the scroll 22 on the touch panel 11 is displayed at the first block. It should be noted that the those skill in the art can randomly define locations of the first block, the second block and the center line or divide them into detail units having many functions and depend upon the design.

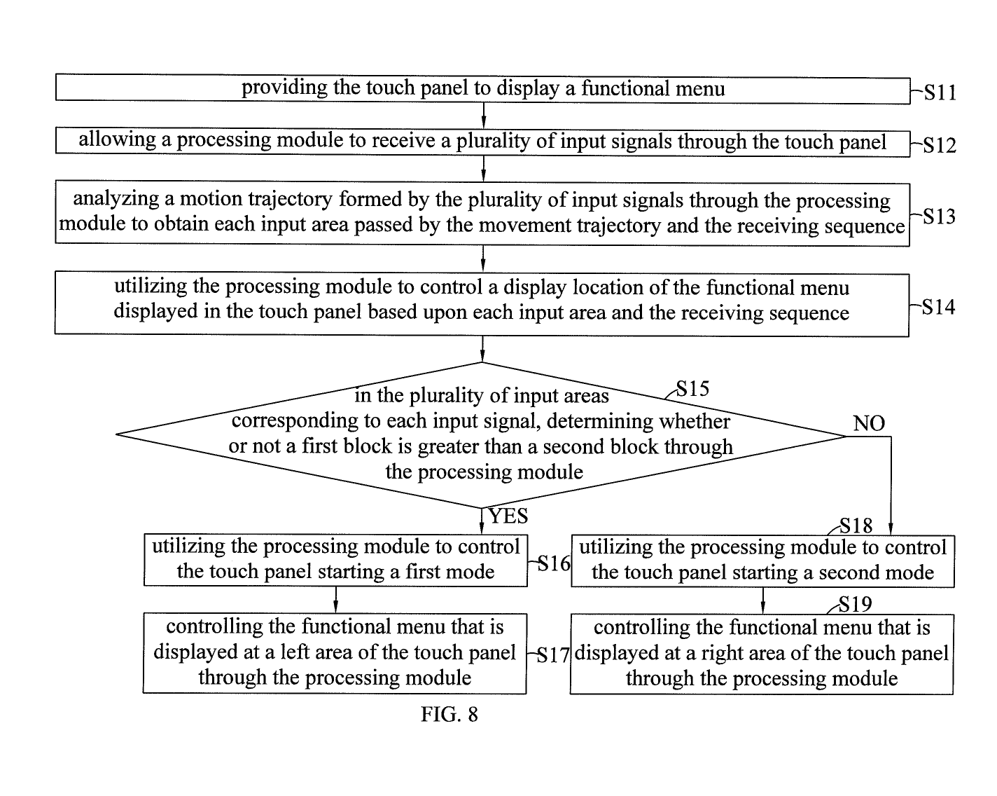

With reference to FIG. 8 for a flowchart of a method for controlling touch panel according to a first embodiment of the invention is depicted. The method for controlling touch panel is applied to the electronic device, and the electronic device has been depicted in the foregoing paragraphs, and there is no need to describe herein. As shown in the figure, the method for controlling touch panel of the electronic device comprises the following steps:

In step S11, providing the touch panel to display a functional menu.

In step S12, allowing a processing module to receive a plurality of input signals through the touch panel.

In step S13, analyzing a motion trajectory formed by the plurality of input signals through the processing module to obtain each input area passed by the movement trajectory and the receiving sequence.

In step S14, utilizing the processing module to control a display location of the functional menu displayed in the touch panel based upon each input area and the receiving sequence.

In step S15, in the plurality of input areas corresponding to each input signal, determining whether or not a first block is greater than a second block through the processing module. If the first block is greater than the second block, a step S16 is performed to utilize the processing module to control the touch panel starting a first mode. After performing the step S16, in step S17, controlling the functional menu to be displayed at a left area of the touch panel through the processing module.

If the first block is smaller than the second block, a step S18 is performed to utilize the processing module to control the touch panel starting a second mode. Next, a step S19 is performed to control the functional menu to be displayed at a right area of the touch panel through the processing module.

The embodiment and detail depiction of the method for controlling touch panel of electronic device have been depicted in the electronic device of the invention, and there is no need to depict herein.

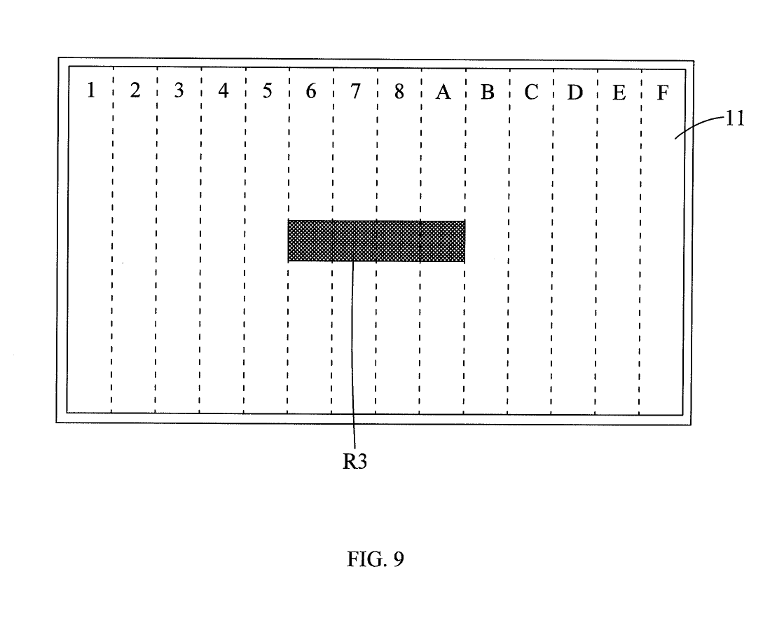

Next, with reference to FIG. 9 for a schematic diagram of an electronic device according to a third embodiment of the invention is depicted. As shown in the figure, the touch panel 11 includes a center line location between a number seven and a number eight.

Two sides of the center line location are a first block and a second block respectively. In the embodiment, a left side of the center line location is the first block, and a right side of the center line location is the second block. The input area R3 passed by a movement trajectory of the finger of the user is a number six and a number A. In the input area R3, the first block equals to the second block. Accordingly, the processing module can analyze which mode should be started by the touch panel 11 based upon the input area R3 corresponding to a last input signal in the several input signal inputted by the user. In another word, if the input area R3 corresponding to the last input signal in the receiving sequence of the input signals inputted by the finger of the user is the number six located at the first block, the processing module controls the touch panel 11 to start the second mode as a right hand mode. If the input area R3 corresponding to the last input signal inputted by the user is the number A located at the second block, the processing module control the touch panel 11 to start the first mode as the left hand mode.

It should be noted that the electronic device comprises a storage module capable of storing each input area R3 corresponding to each input signal and the receiving sequence of the input signals received by the touch panel 11. Therefore, the receiving sequence of the input signals and the input area R3 can be analyzed according to the movement trajectory of the fingers of the user, thereby controlling the operating mode of the touch panel 11 as the right hand mode or the left hand mode.

Moreover, the user can input a trajectory that is from the left side to the right side back and forth or a trajectory that is from the right side to the left side back and forth to control the touch panel 11 releasing the right hand mode or the left hand mode or starting a two-hand mode so that the functional menu can be displayed at many input areas of the touch panel 11.

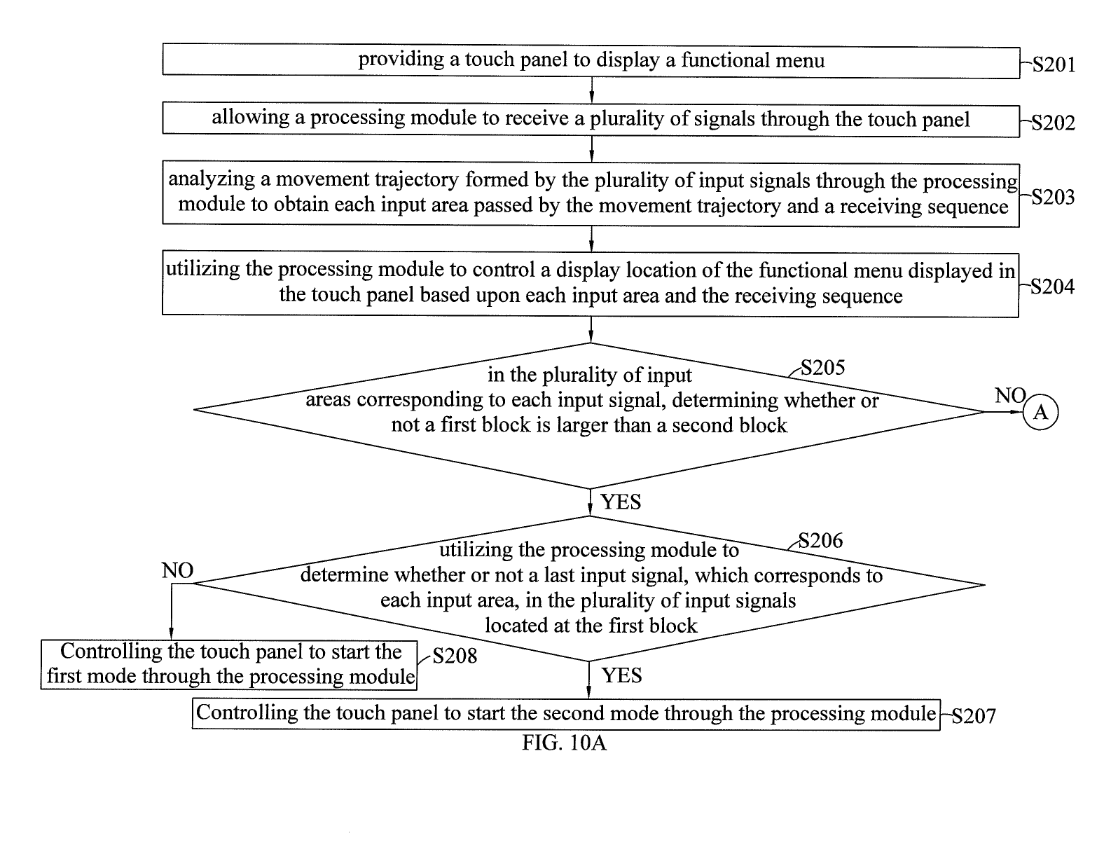

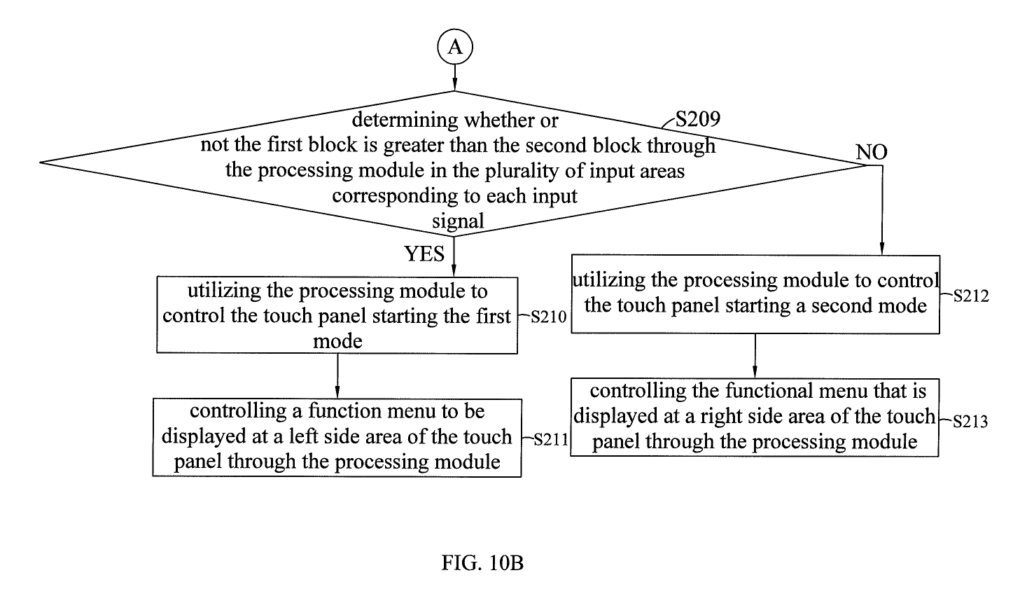

With reference to FIG. 10A and FIG. 10B for a first flowchart and a second flowchart of a method for controlling touch panel according to a second embodiment of the invention are depicted. The method for controlling touch panel of the invention is applied in an electronic device. The detail depiction of the electronic device has been depicted in the foregoing paragraphs, and will not be depicted herein. As shown in FIG. 10A and FIG. 10B, the method for controlling touch panel of the electronic device includes the following steps:

In step S201, providing a touch panel to display a functional menu.

In step S202, allowing a processing module to receive a plurality of signals through the touch panel.

In step S203, analyzing a movement trajectory formed by the plurality of input signals through the processing module to obtain each input area passed by the movement trajectory and a receiving sequence.

In step S204, utilizing the processing module to control a display location of the functional menu displayed in the touch panel based upon each input area and the receiving sequence.

In step S205, in the plurality of input areas corresponding to each input signal, determine whether or not a first block is larger than a second block. If the first block equals the second block, step S206 is performed to utilize the processing module to determine whether or not a last input signal, which corresponds to each input area, in the plurality of input signals located at the first block.

If the last input signal locates at the first block, a step S207 is formed to control the touch panel to start the second mode through the processing module. If the last input signal is not located at the first block or located at the second block, a step S208 is performed to control the touch panel to start the first mode through the processing module.

Return to the step S205, if the first block does not equal to the second block, a step S209 is performed to determine whether or not the first block is greater than the second block through the processing module in the plurality of input areas corresponding to each input signal. If the first block is greater than the second block, a step S210 is performed to utilize the processing module to control the touch panel starting the first mode. After performing the step S210, in a step S211, controlling a function menu to be displayed at a left side area of the touch panel through the processing module.

If the first block is smaller than the second block, a step S212 is performed to utilize the processing module to control the touch panel starting a second mode. Next, a step S213 is performed to control the functional menu to be displayed at a right side area of the touch panel through the processing module.

The embodiment and detail depiction of the method for controlling touch panel of electronic device have been depicted in the electronic device of the invention, and there is no need to depict them herein.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. An electronic device comprising:
a touch panel for displaying a functional menu, the touch panel comprising a plurality of input areas for receiving a plurality of input signals, the plurality of input areas comprising a center line location, two sides of the middle location respectively divided into a first block and a second block; and
a processing module electrically connected to the touch panel, the processing module for analyzing a movement trajectory formed by the plurality of input signals to obtain each input area passed by the movement trajectory and a receiving sequence and for controlling a display location of the functional menu displayed in the touch panel based upon each input area and the receiving sequence;
wherein the processing module determines whether or not the first block is greater than the second block in the plurality of input areas corresponding to each input signal, and when the first block is greater than the second block, the touch panel starts a first mode, and when the first block is smaller than the second block, the touch panel starts a second mode.

2. The electronic device as recited in claim 1, wherein when the movement trajectory is a trajectory that is from a left side to a right side or a trajectory that is from the right side to the left side, the touch panel starts a two-hand mode.

3. The electronic device as recited in claim 2, wherein the two-hand mode is to display a functional menu at the plurality of input areas of the touch panel.

4. The electronic device as recited in claim 1, wherein the first mode is a left hand mode, and when the touch panel starts the first mode, the functional menu is displayed at a left hand side area of the touch panel.

5. The electronic device as recited in claim 4, wherein when the touch panel receives the plurality of input signals from the left side to the right side, the touch panel starts the left hand mode.

6. The electronic device as recited in claim 1, wherein the second mode is a right hand mode, and when the touch panel starts the second mode, the functional menu is displayed at a right hand side area of the touch panel.

7. The electronic device as recited in claim 6, wherein if the touch panel receives the plurality of input signals from the right side to the left side, the touch panel starts the right hand mode.

8. The electronic device as recited in claim 1, wherein the processing module is to dispose the first block at the left side of the center line location and dispose the second block at the right side of the center line location.

9. The electronic device as recited in claim 1, wherein the processing module determines that the first block equals the second block in the plurality of input areas corresponding to each input signal, and when the input area corresponding to a last input signal in the plurality of input signals located at the first block, the touch panel starts the second mode.

10. The electronic device as recited in claim 1, wherein the processing module determines that the first block equals the second block in the plurality of input areas corresponding to the input signal, and when the input area corresponding to a last input signal in the plurality of input signals located at the second block, the touch panel starts the first mode.

11. The electronic device as recited in claim 1, further comprising a storage module, the storage module for storing the input area corresponding to the input signal and the receiving sequence of the input signal received by the touch panel.

12. The electronic device as recited in claim 1, wherein the processing module divides the touch panel into the plurality of input areas, and the plurality of input areas is further separated into the first block and the second block.

13. A method for controlling a touch panel applied in an electronic device, the electronic device comprising a touch panel and a processing module, the touch panel comprising a plurality of input areas, the plurality of input areas comprising a center line location, two sides of the center line location being respectively a first block and a second block, the method for controlling the touch panel comprising:
providing the touch panel to display a functional menu;
receiving a plurality of input signals through the touch panel;
analyzing a movement trajectory formed by the plurality of input signals through the processing module to obtain the input areas passed by the movement trajectory and a receiving sequence;
utilizing the processing module to control a display location of the functional menu displayed in the touch panel based upon the input areas and the receiving sequence; and determining whether or not the first block is greater than the second block in the plurality of input areas corresponding to the input signal, wherein when the first block is greater than the second block, the touch panel starts a first mode, and when the first block is smaller than the second block, the touch panel starts a second mode.

14. The method for controlling a touch panel as recited in claim 13, further comprising a step: controlling the touch panel to start a two-hand mode through the processing module when the movement trajectory is a trajectory that is from a left side to a right side or a trajectory that is from the right side to the left side.

15. The method for controlling a touch panel as recited in claim 14, wherein the two-hand mode is to display the functional menu at the plurality of input areas of the touch panel.

16. The method for controlling a touch panel as recited in claim 13, wherein the first mode is a left hand mode, further comprising a step:
controlling the functional menu to be displayed at a left side area of the touch panel through the processing module when the touch panel starts the first mode.

17. The method for controlling a touch panel as recited in claim 16, further comprising a step:
controlling the touch panel to start the left hand mode through the processing module when the touch panel receives the plurality of input signals from the left side to the right side.

18. The method for controlling a touch panel as recited in claim 13, wherein the second mode is a right hand mode, further comprising a step:
controlling the functional menu to be displayed at a right hand side area of the touch panel through the processing module when the touch panel starts the second mode.

19. The method for controlling a touch panel as recited in claim 18, further comprising a step:
controlling the touch panel to start the right hand mode through the processing module when the touch panel receives the plurality of input signals from the right side to the left side.

20. The method for controlling a touch panel as recited in claim 13, further comprising steps:
disposing the first block at a left side of the center line location through the processing module; and
disposing the second block at a right side of the center line location through the processing module.

21. The method for controlling a touch panel as recited in claim 13, further comprising a step:
determining whether or not the first block equals the second block in the plurality of input areas corresponding to the input signal through the processing module, and controlling the touch panel to start the second mode through the processing module when the input area corresponding to a last input signal in the plurality of input signals located at the first block.

22. The method for controlling a touch panel as recited in claim 13, further comprising a step:
determining whether or not the first block equals the second block in the plurality of input areas corresponding to the input signal through the processing module, and controlling the touch panel to start the first mode through the processing module when the input area corresponding to a last input signal in the plurality of input signals located at the second block.

23. The method for controlling a touch panel as recited in claim 13, wherein the electronic device comprising a storage module, further comprising a step:
utilizing the storage module to store the input area corresponding to the input signal and the receiving sequence of the input signal received by the touch panel.

24. The method for controlling a touch panel as recited in claim 13, further comprising steps:
dividing the touch panel into the plurality of input areas through the processing module; and
separating the plurality of input areas into the first block and the second block through the processing module.
